(19) United States
(12) Patent Application Publication
(10) Pub. No.: US 2024/0314666 A1
(43) Pub. Date: Sep. 19, 2024

(54) PROCEDURAL OPTIONS FOR CHO IN NON-TERRESTRIAL NETWORKS

(71) Applicant: Telefonaktiebolaget LM Ericsson (PUBL), Stockholm (SE)

(72) Inventors: Claes-Göran Persson, MJÖLBY (SE); Helka-Liina Määttänen, Espoo (FI); Johan Rune, LIDINGÖ (SE); Emre Yavuz, STOCKHOLM (SE); Chao He, SOLLENTUNA (SE)

(21) Appl. No.: 18/261,302

(22) PCT Filed: Jan. 14, 2022
(86) PCT No.: PCT/IB2022/050321

§ 371 Date: Jul. 13, 2023

Related U.S. Application Data
(60) Provisional application No. 63/137,634, filed on Jan. 14, 2021.

(51) Int. Cl. H04W 36/36; H04W 36/00; H04W 36/32; H04W 84/06

(52) U.S. Cl. CPC H04W 36/362; H04W 36/0072; H04W 36/008355; H04W 36/00837; H04W 36/322; H04W 84/06

(57) ABSTRACT

Methods and systems are described for triggering conditional handovers in user equipment, such as wireless devices in communication systems. Triggering conditions can comprise location, timer, and signal quality-based conditions. Triggering conditions can be combined together and can be evaluated in hierarchical order depending on user preference, so as to prioritize location, timer, signal quality, or other factors.

### CROSS REFERENCE TO RELATED INFORMATION

This application claims the benefit of U.S. Provisional Patent Application No. 63/137,634 filed on Jan. 14, 2021, titled “Procedural Options for CHO in Non-Terrestrial Networks,” the contents of which are hereby incorporated herein in its entirety.

### TECHNICAL FIELD

The present disclosure generally relates to the technical field of wireless communications and handover between cells.

### BACKGROUND

In Third Generation Partnership Project (3GPP) Release 8, the Evolved Packet System (EPS) was specified. EPS is based on the Long-Term Evolution (LTE) radio network and the Evolved Packet Core (EPC). It was originally intended to provide voice and mobile broadband (MBB) services but has continuously evolved to broaden its functionality. Since Release 13 Narrowband Internet-of-Things (NB-IoT) and LTE for Machine-Type-Communications (MTC) (LTE-M) are part of LTE specifications and provide connectivity to massive machine type communications (mMTC) services.

In 3GPP Release 15, the first release of the Fifth Generation (5G) System (5GS) was specified. This is a new generation's radio access technology intended to serve use cases such as enhanced mobile broadband (eMBB), ultra-reliable and low latency communication (URLLC) and mMTC. 5G includes the New Radio (NR) access stratum interface and the 5G Core Network (5GC). The NR physical and higher layers are reusing parts of the LTE specification, and additional components are introduced when motivated by the new use cases.

### 3GPP Support for Non-Terrestrial Networks

In Release 15, 3GPP also started the work to prepare NR for operation in a Non-Terrestrial Network (NTN). The work was performed within the study item “NR to support Non-Terrestrial Networks” and resulted in 3GPP TR 38.811. In Release 16 the work to prepare NR for operation in an NTN network continues with the study item “Solutions for NR to support Non-Terrestrial Network.” In parallel the interest to adapt LTE for operation in NTN is growing. As a consequence, 3GPP is considering introducing support for NTN in both LTE and NR in Release 17.

### Characteristics of a Non-Terrestrial Network

A satellite radio access network usually includes the following components:
A satellite that refers to a space-borne platform.
An earth-based gateway that connects the satellite to a base station or a core network, depending on the choice of architecture.
Feeder link that refers to the link between a gateway and a satellite
Access link (or Service link) that refers to the link between a satellite and a user equipment (UE).

Depending on the orbit altitude, a satellite may be categorized as low earth orbit (LEO), medium earth orbit (MEO), or geostationary earth orbit (GEO) satellite.
LEO: typical heights ranging from 250-1,500 km, with orbital periods ranging from 90-120 minutes.
MEO: typical heights ranging from 5,000-25,000 km, with orbital periods ranging from 3-15 hours.
GEO: height at about 35,786 km, with an orbital period of 24 hours.

The significant orbit height means that satellite systems are characterized by a path loss that is significantly higher than what is expected in terrestrial networks. To overcome the pathloss it is often required that the access and feeder links are operated in line-of-sight conditions, and that the UE is equipped with an antenna offering high beam directivity.

A communication satellite typically generates several beams over a given area. The footprint of a beam is usually in an elliptic shape, which has been traditionally considered as a cell. The footprint of a beam is also often referred to as a spotbeam. The spotbeam may move over the earth surface with the satellite movement or may be earth fixed with some beam pointing mechanism used by the satellite to compensate for its motion. The size of a spotbeam depends on the system design, which may range from tens of kilometers to a few thousands of kilometers.

FIG. 1 shows an example architecture of a satellite network with bent pipe transponders, also known as transparent payload. The NTN beam may in comparison to the beams observed in a terrestrial network be very wide and cover an area outside of the area defined by the served cell. Beam covering adjacent cells will overlap and cause significant levels of intercell interference. To overcome the large levels of interference a typical approach in NTN is to configure different cells with different carrier frequencies and polarization modes. Throughout this disclosure, the terms beam and cell may be used interchangeably, unless explicitly noted otherwise.

### Connected-State Mobility

In connected state, in the 3GPP specifications known as the RRC_CONNECTED state, a UE has a connection established to the network for sending and receiving of data and signaling. The aim of connected-state mobility is to ensure that the connectivity is retained with no interruption or noticeable degradation as the UE moves between cells within the network. The UE is required to do searches and perform measurements for new cells (neighbor cells) both on the current carrier frequency (intra-frequency) and different carrier frequencies (inter-frequency) that are informed by the network. The UE does not make any decisions on its own regarding when it is time to trigger a handover procedure to a neighbor cell (except partly in the case of conditional handover). This is rather based on a variety of triggering conditions configured by the network. In general, the UE reports the results of any configured measurements to the network so that the network can make a decision on whether or not it is time for handover to a neighbor cell. However, when conditional handover is used, the network partly “delegates” the execution decision to the UE by instructing it to execute a handover to a candidate target cell when certain trigger conditions are fulfilled.

In 5G NR, handover is a special case of a procedure called “reconfiguration with sync.” In addition, a variety of handover mechanisms, such as Dual Active Protocol Stack (DAPS) handover, conditional handover (CHO), and RACH-less HO (only for LTE), have been introduced in specifications to enhance the mobility performance for challenging scenarios that require short interruption time, low-latency and high reliability performance. This disclosure concerns details of CHO.

### Conditional Handover (CHO)

When the radio link becomes degraded and the UE needs to send measurement reports, it is possible that those reports will never reach the network since the uplink link is degraded. But even if they do, the network tries to respond with a handover command that may never reach the UE, either since the downlink is degraded or the handover command is so large that multiple transmissions are required. In an NTN, even if the UE may know for how long time a satellite/cell may serve a certain geographical area before the service link switch (e.g., with the help of ephemeris data), channel conditions such as certain terrain, may still yield limited accessibility (e.g., UE is shadowed by a mountain). FIG. 2 shows when these two cases might happen.

The main motivation of the conditional handover mechanism is to reduce the number of failure occurrences while a UE is moving, e.g., when a handover between cells fails, or when a connection fails even before a handover (HO) is triggered.

In conditional handover, instead of preparing one target cell as in a regular (non-CHO) handover, one or more candidate target cells are prepared in advance in the network. This enables the network to send the handover command to the UE at an earlier stage compared to a regular handover, i.e., the handover command is sent when the radio conditions are still good, rather than when the radio conditions start to get degraded as in a regular handover. When received, the UE stores the handover command (and the Radio Resource Control (RRC) configurations included in the message), instead of applying it immediately, and starts to evaluate the CHO trigger condition(s) configured by the network. The UE only applies the stored handover command (and the associated RRC configuration) when the CHO trigger condition(s) configured by the network is satisfied for one of the configured candidate target cells. Then the UE executes the handover and connects to the target node as in a regular handover.

In conditional handover, instead of transmitting the measurement report, the UE applies the stored handover command message (and the associated RRC configuration) when the CHO trigger condition is satisfied for one of the configured candidate target cells. The network may also configure two CHO trigger conditions for the UE and associate both to the stored handover command, i.e., the handover command is applied only if both CHO trigger conditions are fulfilled (e.g., conditions configured for different types of measurement quantities, like cell coverage represented by Reference Signal Received Power (RSRP), and quality represented by Reference Signal Received Quality (RSRQ)).

It is also possible that a failure is detected while the UE is monitoring the configured conditions. In legacy, the UE would perform cell selection and continue with a re-establishment procedure. However, with conditional handover, when the same type of failure is detected (e.g., a radio link failure or handover failure), the UE can prioritize a cell for which it has a stored handover command and, instead of performing re-establishment, it performs a conditional handover, which reduces the interruption time and the signaling over the air interface. FIG. 3 illustrates a simplified message diagram for an inter-gNB Conditional Handover. The RRCReconfiguration* indicated with an asterisk (‘*’) is the Handover Command containing the RRC reconfiguration the UE shall apply if/when connecting to the candidate target gNB.

### SUMMARY

One embodiment under the present disclosure comprises a method performed by a user equipment for triggering conditional handover. The method comprises receiving information from a network node, the information indicating one or more trigger conditions for triggering a conditional handover to a target cell. It can further comprise determining whether a first of the one or more trigger conditions has been met; and triggering the conditional handover based at least in part on determining that the first trigger condition has been met.

Another embodiment under the present disclosure comprises a method performed by a base station for triggering conditional handover in a user equipment. The method comprises transmitting information to a user equipment, the information indicating one or more trigger conditions for triggering a conditional handover.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

For a more complete understanding of the present disclosure, reference is now made to the following descriptions taken in conjunction with the accompanying drawings, in which:

FIG. 1 shows an example architecture of a satellite network with bent pipe transponders;

FIG. 2 shows an example of mobility-related failure;

FIG. 3 shows an example of Simplified message diagram for an inter-gNB Conditional Handover;

FIG. 4 shows a flow chart of a method embodiment under the present disclosure;

FIG. 5 shows a wireless network in accordance with some embodiments of the present disclosure;

FIG. 6 shows a user equipment embodiment under the present disclosure;

FIG. 7 shows a virtualization environment in accordance with some embodiments of the present disclosure;

FIG. 8 shows a telecommunication network connected via an intermediate network to a host computer in accordance with some embodiments of the present disclosure;

FIG. 9 shows a host computer communicating via a base station with a user equipment over a partially wireless connection in accordance with some embodiments of the present disclosure;

FIG. 10 shows methods implemented in a communication system including a host computer, a base station and a user equipment in accordance with some embodiments of the present disclosure;

FIG. 11 shows methods implemented in a communication system including a host computer, a base station and a user equipment in accordance with some embodiments of the present disclosure;

FIG. 12 shows methods implemented in a communication system including a host computer, a base station and a user equipment in accordance with some embodiments of the present disclosure;

FIG. 13 shows methods implemented in a communication system including a host computer, a base station and a user equipment in accordance with some embodiments of the present disclosure;

FIG. 14 shows a virtualization apparatus in accordance with some embodiments of the present disclosure; and

FIG. 15 shows a method implemented by a base station in accordance with some embodiments of the present disclosure.

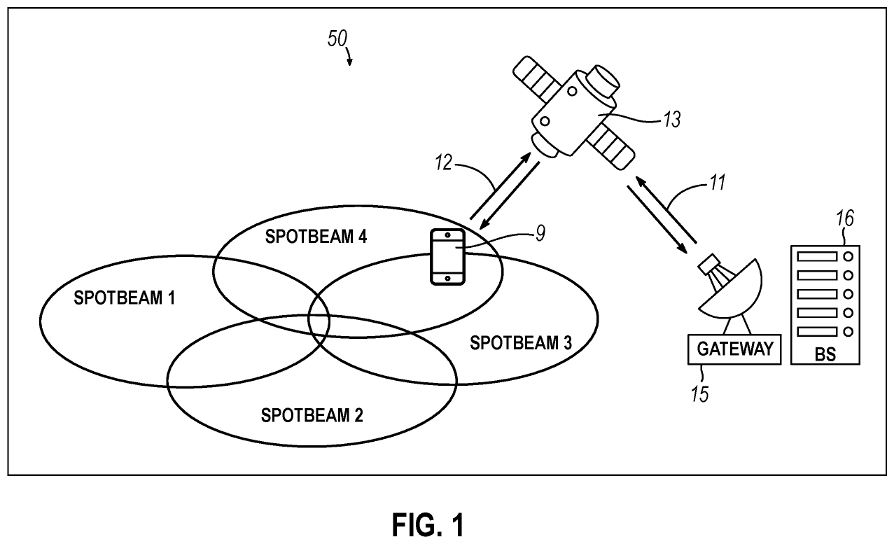

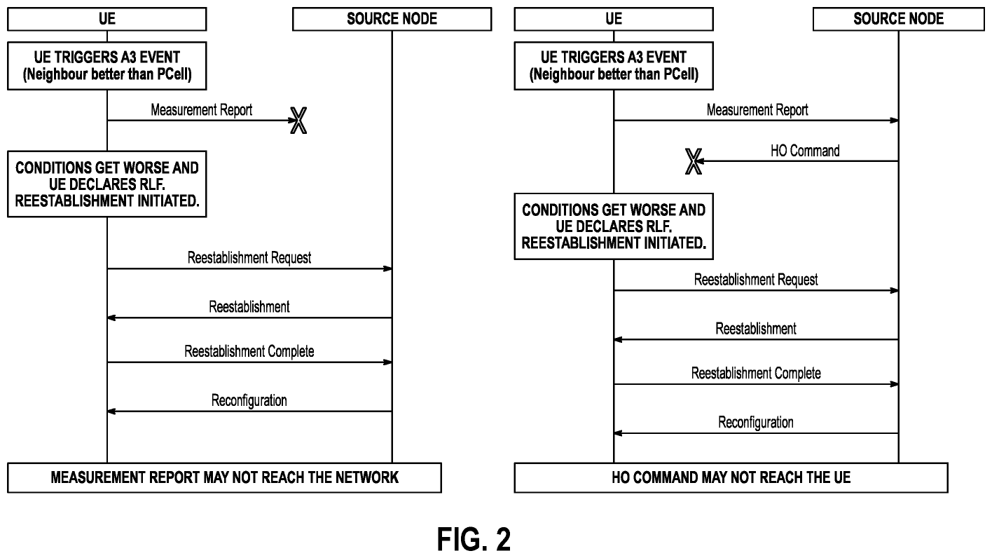

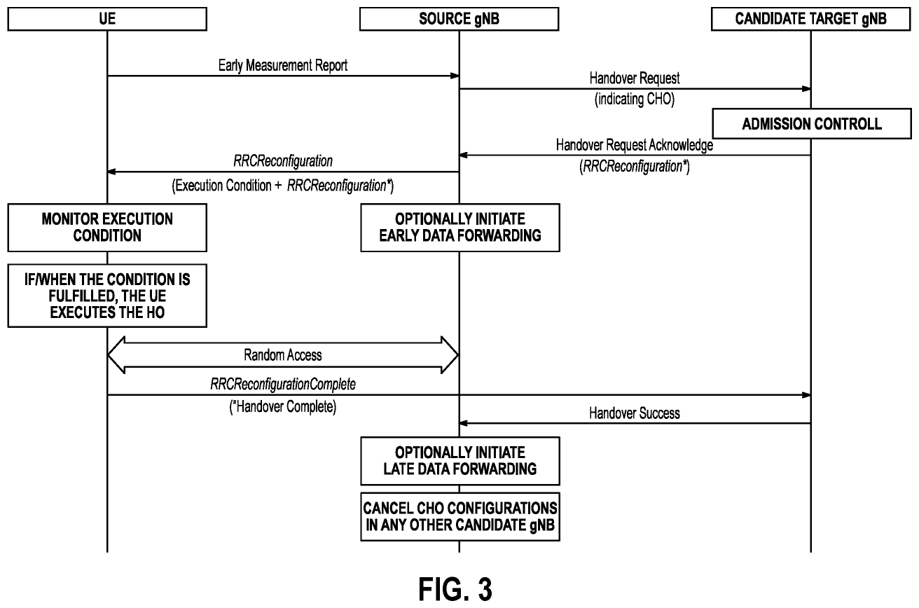

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed embodiments. In addition, the terminology used herein is for the purpose of describing the embodiments and is not necessarily intended to limit the scope of the claimed embodiments.

There currently exist certain challenge(s) for conditional handovers. For example, as CHO is defined in Rel-16, the UE can be configured with multiple candidate target cells where each candidate target cell may be configured with up to two CHO trigger conditions, A3 and A5 signal strength/quality-based events. The CHO trigger condition is autonomously evaluated by the UE, and if two CHO trigger conditions are configured, the UE may only trigger the handover if both CHO trigger conditions are fulfilled for one of the candidate target cells.

This is expected to work well when CHO is configured in a terrestrial network where the cells are characterized by a clear difference in signal strength between the cell center and the cell edge. But for a CHO configuration in an NTN deployment, it is not obvious the CHO procedure as defined in Rel-16 will always work when the time/timer-based and location-based trigger conditions are added as additional CHO trigger conditions to the already existing Rel-16 CHO trigger conditions and the CHO procedure is kept unchanged.

Only relying on a time/timer or a location-based event to trigger a CHO, without assessing the signal strength/quality of the candidate target cell, will not be sufficient in some NTN handover scenarios since this could easily end up in unpredictable behavior such as subsequent handovers or RLF. To avoid this, in embodiments under the present disclosure, the time/timer or location-based event can be configured with a signal strength/quality measurement-based event to secure a CHO to a ‘safe’ candidate target cell. The existing CHO events A3 and A5 can possibly serve as signal strength/quality measurement events, but also the A4 event (Neighbour becomes better than threshold) could be defined as an additional CHO event.

Assuming the network can predict the time when the UE needs to perform the handover to a neighbor cell (e.g., when a periodic feeder/service link switch is to be performed), the time (or timer) triggering the CHO will typically be set in time before the signal strength/quality of the serving cell becomes too weak, but late enough so that the signal strength/quality of the target cell is guaranteed, thus a single time/timer event triggering a CHO to a candidate target cell should not be precluded.

Considering the large variety of handover scenarios and use cases expected in NTN deployments, the CHO evaluation logic and trigger conditions as defined in 3GPP Rel-16 for terrestrial networks will pose a limitation for the network and for the UE when CHO is applied in NTN. That is, there are multiple details related to the handling of these newly agreed CHO trigger conditions, location and time/timer events, together with the existing signal strength/quality trigger conditions (A3 and A5 events), which cannot be captured with a procedure logic in line with the procedure logic for CHO specified for 3GPP Rel-16.

Certain aspects of the present disclosure and their embodiments may provide solutions to these or other challenges. For example, the present disclosure proposes different ways of handling these newly agreed CHO trigger conditions, location and time/timer, together with the existing signal strength/quality trigger conditions. There are, proposed herein, various embodiments which address one or more of the issues and problems identified above.

Certain embodiments may provide one or more of the following technical advantage(s). Certain embodiments provide network implementation flexibility, for example, by generalizing where RRC parameter is added to configure the procedural option. Considering the large variety of handover scenarios and use cases expected in NTN deployments, there is a need for such flexibility in order to better support different kinds of procedures. Certain embodiments may increase the likelihood of successful handover. Certain embodiments may decrease the likelihood of radio link failure. Certain embodiments may facilitate a more optimal timing for a handover and/or selection of target cell. Depending on the exact procedure, different advantages may be derived.

In a situation where the configured time/timer is, for whatever reason, not accurately set (e.g., if the timer is set too long delaying the handover beyond a point where the signal strength/quality of the serving cell becomes too weak), the signal strength/quality-based events (e.g., A3 or A5) can assist as a ‘last resort’ to trigger a handover to the target cell. This could be useful for example in an earth fixed cell scenario where it may be difficult to pinpoint the exact point in time when to trigger a handover if the UE speed and the direction of the UE movement is not known to the network. Potentially, it may also be useful at an initial stage of an NTN deployment when the network parameters are not fully adjusted.

Similarly, if a location-based trigger condition is configured to the UE and the present location in relation to the serving cell center or to the target cell center is temporarily unknown or incorrect thus misleading the UE, the signal strength/quality-based trigger conditions can be used as a fallback solution to trigger a CHO.

The disclosure is described with reference to NTN, but the methods proposed apply to any wireless network dominated by line-of-sight conditions. Unless otherwise stated explicitly the methods proposed below concern both fixed and moving cells, service and feeder link switches.

When CHO is configured for a UE, a cell which the UE potentially can connect to (i.e., if the CHO execution condition is fulfilled for the cell) may be denoted as “candidate target cell”. Similarly, a RAN node controlling a candidate target cell can be denoted as “candidate target node”. However, once the UE has detected a fulfilled CHO execution condition for a candidate target cell, this terminology may adjust slightly. At this point, during the actual execution of the CHO and when the UE has connected to the new cell, the concerned cell may be referred to as either a “candidate target cell” or a “target cell”. Similarly, a RAN node controlling such a cell, may in this situation be referred to as either a “candidate target node” or a “target node”.

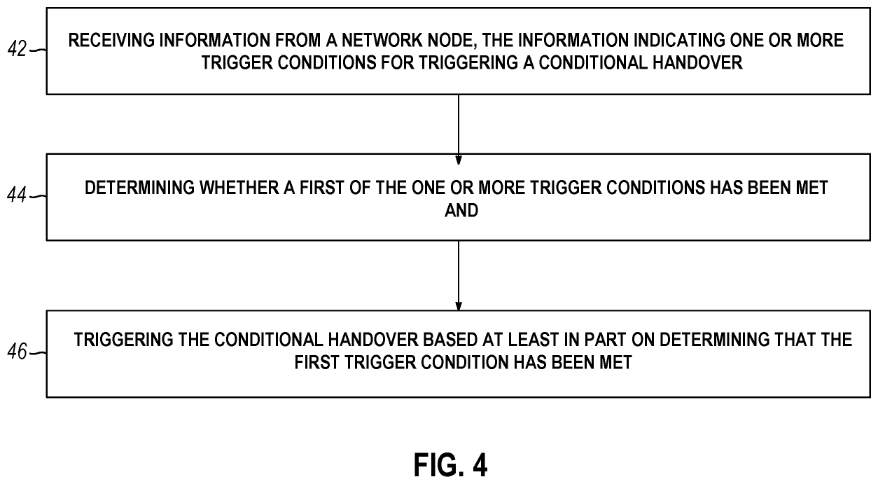

FIG. 4 depicts a method 40 in accordance with particular embodiments of the present disclosure. The method may be performed by a wireless device, such as wireless device 110 or UE 200 described below. The method 40 begins at step 42 with receiving information from a network node. The information indicates one or more trigger conditions for triggering a conditional handover. The method proceeds to step 44 with determining whether a first of the one or more trigger conditions has been met. The method continues to step 46 with triggering the conditional handover based at least in part on determining that the first trigger condition has been met. Examples of the one or more trigger conditions include any of the conditions or events described below, see e.g., the embodiments discussed under the headings “First Set of Embodiments (which events can or cannot be configured for the UE),” “Second Set of Embodiments (details for the event definitions and/or applicability,” and “Third Set of Embodiments (how UE evaluates the events and triggers the CHO for NTN).”

### First Set of Embodiments (which Events can or Cannot be Configured for the UE)

In one embodiment, the location and time/timer-based CHO trigger conditions can be configured for the UE for a target/serving cell when signal strength/quality-based triggers are not configured. In a variant embodiment, only time/timer or location or signal strength/quality-based triggers can be configured.

In another embodiment, the location condition and the time/timer-based condition can be configured together.

In another embodiment, the location and/or time/timer-based CHO trigger condition can be configured together with signal strength/quality-based triggers. In a variant, there is a UE capability that defines whether UE supports location-based CHO trigger, defines whether UE supports time/timer-based CHO trigger, and whether that is supported with location based CHO trigger, or time/timer based CHO trigger, or signal strength/quality based triggers.

In another embodiment, the location and/or time/timer-based CHO trigger condition has to be always configured together with signal strength/quality-based triggers.

### Second Set of Embodiments (Details for the Event Definitions and/or Applicability)

In one embodiment, the location-based event is defined such that UE is given, either in measurement or CHO configuration, or in other RRC dedicated configuration, or read from system information or obtained from Ephemeris information provided by any manner (preconfigured, NAS, RRC) the serving cell reference center point and target candidate cell center point/location (coordinates). Then, the actual event is defined such that the distance to serving cell center is longer that the distance to target candidate cell center. Or, alternatively, any other combination can comprise using the distance measure of to/from serving and/or candidate target cell.

In one embodiment some CHO events are defined either by specification or by RRC parameters to be UE specific such that those are not evaluated per target candidate cell but e.g., as UEs distance to/from serving cell center. Or, as time/timer. In this case, in procedural text, these are not checked per target candidate cell but per measurement ObjectNR (or EUTRA).

### Third Set of Embodiments (how UE Evaluates the Events and Triggers the CHO for NTN)

Rel-16 CHO events (A3 and A5 events) are configured and provided to the UE in the ReportConfigNR IE included in the MeasConfig IE and it is expected that the new Rel-17 CHO events (time/timer and location-based events) will be configured in the same IE. In Rel-16 each candidate target cell can be configured with maximum two CHO events. The methods as described below are not limited by this number.

In one embodiment, an evaluation method in which the UE simultaneously evaluates all CHO events for all candidate target cells that are configured for the UE but only when all CHO events are fulfilled for one candidate target cell, a CHO is triggered to that candidate target cell. In a variant, only a subset of all possible CHO events are configured for all candidate target cells or for each candidate target cell a different set of CHO events are configured. In an alternative, the evaluation method could potentially also be configured per candidate target cell (different evaluation method for each candidate target cell).

In another embodiment, an evaluation method in which the UE evaluates all or a subset of all possible CHO events for all candidate target cells simultaneously and when one CHO event fulfills the execution condition for one candidate target cell, a CHO is triggered to that candidate target cell. In another embodiment, an evaluation method in which the UE evaluates all or a subset of all possible CHO events for all candidate target cells simultaneously and when multiple CHO events (out of those CHO events configured) fulfill the execution condition for one candidate target cell, a CHO is triggered to that candidate target cell.

In another embodiment, an evaluation method in which the UE evaluates one CHO event at a time in a hierarchical order, e.g., when the first CHO event is fulfilled, the UE starts to evaluate the second CHO event. Only when both CHO events are fulfilled for a candidate target cell, a CHO is triggered to that candidate target cell. Such hierarchical order of CHO events may be used to decide the sequential order of the evaluations of different CHO events. This means that all events can be evaluated according to the hierarchical order where the evaluated values of events on the current level do not decide whether the evaluation of the events on a lower level will take place or not. Alternatively, the hierarchical order of CHO events evaluation may be used to reduce the number of the events evaluation performed. That is the evaluated values of events on the current level can decide whether the evaluation of the events on a lower level will take place or not.

In another embodiment, the above-described hierarchical evaluation order is generalized to an arbitrary number of hierarchical levels. That is, the UE first evaluates one condition (or multiple conditions in parallel) at the highest hierarchical level. When that condition is fulfilled (or those conditions are fulfilled), the UE evaluates the condition(s) at the next hierarchical level and when that condition is fulfilled (or those conditions are fulfilled), the UE evaluates the condition(s) at the next hierarchical level, and so on. Only when the trigger conditions (CHO events) on all hierarchical levels have been fulfilled does the UE execute the handover.

In another embodiment, an evaluation method in which the UE evaluates one CHO event at a time in a hierarchical order where each condition is configured with a different priority, e.g., the first condition has an higher priority than the second one, and CHO is triggered if the first one is fulfilled, but if the second one is fulfilled, UE has to also make sure that the first one is fulfilled to trigger CHO.

In another embodiment, when the outcome of the above-described hierarchical evaluation methods will be none of the target cells fulfills all CHO events required, a fallback to a second round all CHO events evaluation can be triggered so that UE can evaluate all or a subset of all possible CHO events for all or a subset (subset selected based on the first round evaluation) of candidate target cells.

In another embodiment, the evaluated values of each CHO event can be given a weight to calculate a score that shows the overall performance of each candidate target cell, when none of the target cells fulfills all CHO events required. The scores may be used as reference to choose to which candidate target cell the HO can be performed.

In another embodiment, the events can be configured such that the configuration describes which events follow one of the above-mentioned options. For example, a UE may be configured with the time/timer, and only after the time/timer event (or location or signal quality/strength that is any indicated event) is fulfilled, the UE starts to evaluate the rest of the events. Alternatively, the UE evaluates all events for all target cells but only when the indicated event is fulfilled does the UE consider that target cell. For example, if UE is very close to the cell center there is no point in evaluating the RSRP and therefore location information alone may be sufficient to trigger CHO, but there may also be cases where such condition alone would not be enough.

In another variant, there may be two values for the location (or time). When the location and/or timer-based triggers reach first (set of) value(s), it can start the event evaluation for some other configured events (e.g., location or signal strength/quality). When the second (set of) value(s) are reached, it may trigger the CHO even if the other events are not fulfilled. For example, if the second value for the time/timer triggers (e.g., a second timer expires or a second threshold time is exceeded), the UE starts the HO even if the signal strength-based event has not yet been evaluated for time to trigger amount of time. Alternatively, second value for the event is needed together with another event configured.

In another embodiment, a first condition may be that the UE's distance from the service cell's center exceeds a first threshold value. When this is fulfilled the UE should execute the handover to a candidate target cell if a channel quality based condition, e.g., an A4 event (or an A5 or A3 event) is fulfilled (hence, the UE does not have to evaluate the channel quality condition, or even measure the concerned channel quality/qualities, before the first condition has been fulfilled). But if the UE's distance from the serving cell's center exceeds a second threshold value (which is greater than the first threshold value), the UE should execute the handover irrespective of the concerned channel quality/qualities, i.e., irrespective of whether the channel quality condition has been fulfilled.

In a variation of the above example, a first condition may be that the UE's distance from the service cell's center exceeds a first threshold value. When this is fulfilled the UE should execute the handover to a candidate target cell if a channel quality based condition, e.g., an A4 event (or an A5 or A3 event) is fulfilled (hence, the UE does not have to evaluate the channel quality condition, or even measure the concerned channel quality/qualities, before the first condition has been fulfilled). But if a third condition is fulfilled, the UE should execute the handover irrespective of the concerned channel quality/qualities, i.e., irrespective of whether the channel quality condition has been fulfilled. The third condition may be e.g., that the UE's distance to a candidate target cell's center becomes smaller than a second threshold value.

In another embodiment, two (or more) location-based trigger conditions may be configured together, to be evaluated in parallel or in hierarchical order. In an example with multiple location-based trigger conditions to be hierarchically evaluated, a first location-based condition—at the first (i.e., highest) hierarchical level)—is that the UE's distance to the serving cell's center exceeds a first threshold value. When this is fulfilled, the UE evaluates one or more trigger conditions at the second hierarchical level in parallel, where each of these one or more second level conditions is associated with a certain candidate target cell and may be that the UE's distance to the candidate target cell's center is smaller than a second threshold value (where this second threshold value may be the same for all candidate target cells or may be different for different candidate target cells). As another option, each of the second level conditions may be that the UE has entered an area, e.g., defined as an ellipse, a circle a rectangle, a triangle, a hexagon or a regular or irregular polygon (where this area may represent an area in which it is suitable to execute a handover to the associated candidate target cell).

In CHO as specified in 3GPP Rel-16, the two trigger conditions that may be configured are considered to be combined with logical AND. In some embodiments of this solution, the logic is not limited to the AND operation, but may also include logical OR and logical XOR (e.g., Boolean logic). Thus, if two trigger conditions are configured combined with logical OR, the handover execution is triggered if at least one of the conditions is fulfilled. Similarly, if two trigger conditions are configured combined with logical OR, the handover execution is triggered if one and only one of the conditions is fulfilled.

In some embodiments, more complex logical expressions may also be configured, e.g., nested logical expressions, for instance that handover execution is triggered if the expression “cond1 AND (cond2 OR (cond3 AND cond4))” is evaluated to TRUE (i.e., it is fulfilled).

The above-described logical descriptions may also be combined with the hierarchical condition evaluation, such that logical expression conditions may be present at any hierarchical level.

In another embodiment, how to evaluate the configured CHO events in the ReportConfigNR IE (according to the evaluation methods above) can for example be indicated by a new parameter in the RRC message, for example included in the ReportConfigNR IE or in the CondReconfigToAddModList IE. The new parameter may either indicate the same CHO evaluation method for all candidate target cells (the UE evaluates all candidate target cells according to the indicated evaluation method) or the parameter may indicate an evaluation method on a per candidate target cell basis (i.e., candidate target cells may be evaluated with different evaluation methods). In another embodiment, how to evaluate the configured CHO events in the ReportConfigNR IE is indicated by the order the CHO events are configured in e.g., the CondReconfigToAddModList IE. If e.g., the list of configured CHO events contains two CHO events and the first CHO event is either the time/timer or the location-based event, then the time/timer or the location-based event need to be fulfilled before the UE starts to evaluate the second CHO event. Only when both CHO events are fulfilled for a candidate target cell, a CHO is triggered.

In another embodiment, a hierarchical event evaluation order indicated in the ReportConfigNR IE may be complemented (also in the ReprotConfigNR IE) by an indication of an event which overrides the hierarchical evaluation, such that when this event (or combination of events) is(are) fulfilled, the UE executes the handover irrespective of the other events, or, as one option, irrespective of any hierarchically lower events (i.e., events that are lower in the hierarchical event evaluation order). As an option, this configuration may be realized using a logical expression with the OR operator between the hierarchically evaluated events and the overriding event. Note that the overriding event may itself be a combination of events, e.g., in the form of a logical expression.

The location in above embodiments and/or their variants can be substituted with a combination of an original location indicator, an accelerometer (or a velocity sensor), and a timer. Note that the velocity sensor or the accelerometer will most likely not use GNSS receiver. Such variants can reduce the frequency that GNSS receiver are called in in a UE implementation. Similarly, applying/adapting the above embodiments and/or variants with other measurements, e.g., the elevation angle of serving/target satellites, timing advance values, location of satellites, distances between satellites and UE, etc., is not precluded.

In addition, the capability definition may include some requirements on UEs ability to obtain and maintain its location and/or time, and there may be UE conformance test for it.

### Further Description of Embodiments

Certain embodiments of the present disclosure may be implemented in a network node (e.g., gNB, eNB, communication satellite). Certain embodiments may be implemented in a wireless device. Certain embodiments may be implemented in the context of a 3GPP Non-Terrestrial Network, such as a network according to NR TR 38.821 Rel-16 Solutions for NR to support NTN, 3GPP TS 38.331, etc. Certain embodiments relate, in general, to the technical areas of LEO, GEO, MEO, ephemeris, broadcast, feeder link, service link, handover, mobility, reconfiguration with sync, conditional handover, measurement reports, and/or handover command.

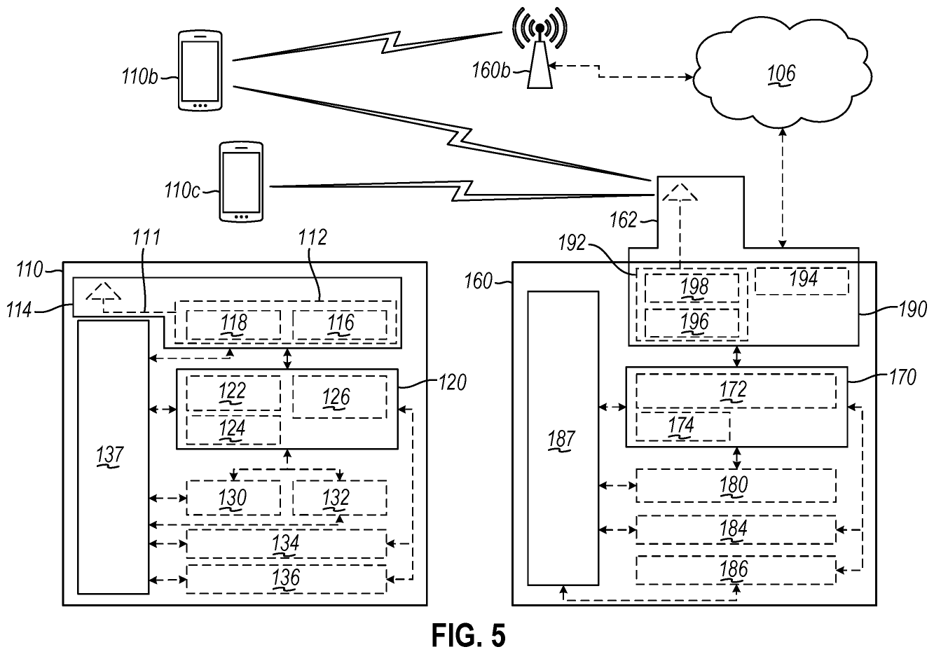

Although the subject matter described herein may be implemented in any appropriate type of system using any suitable components, the embodiments disclosed herein are described in relation to a wireless network, such as the example wireless network illustrated in FIG. 5. For simplicity, the wireless network of FIG. 5 only depicts network 106, network nodes 160 and 160b, and wireless devices (WDs) 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and WD 110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 5, network node 160 includes processing circuitry 170, device readable medium 180, interface 190, auxiliary equipment 184, power source 186, power circuitry 187, and antenna 162. Although network node 160 illustrated in the example wireless network of FIG. 5 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality. For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160, but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signalling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162. Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160. For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 5 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120, and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114. Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips. In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner. In any of those particular embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110 as a whole, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be considered to be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected). User interface equipment 132 may include input interfaces, devices and circuits, and output interfaces, devices and circuits. User interface equipment 132 is configured to allow input of information into WD 110, and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network, and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry. Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

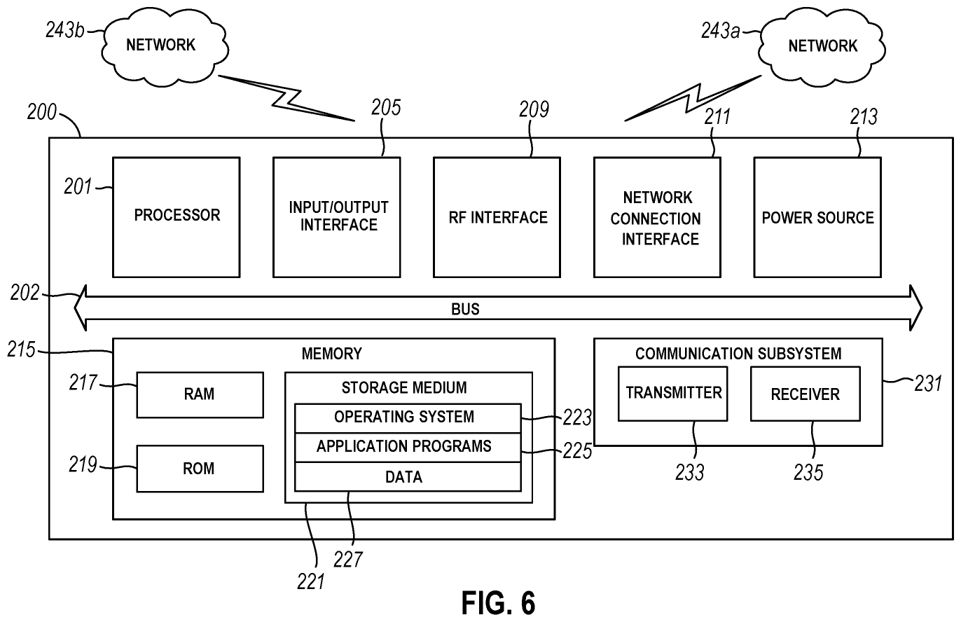

FIG. 6 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 2200 may be any UE identified by the 3rd Generation Partnership Project (3GPP), including a NB-IoT UE, a machine type communication (MTC) UE, and/or an enhanced MTC (eMTC) UE. UE 200, as illustrated in FIG. 6, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 6 is a UE, the components discussed herein are equally applicable to a WD, and vice-versa.

In FIG. 6, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 213, and/or any other component, or any combination thereof. Storage medium 221 includes operating system 223, application program 225, and data 227. In other embodiments, storage medium 221 may include other similar types of information. Certain UEs may utilize all of the components shown in FIG. 6, or only a subset of the components. The level of integration between the components may vary from one UE to another UE. Further, certain UEs may contain multiple instances of a component, such as multiple processors, memories, transceivers, transmitters, receivers, etc.

In FIG. 6, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205. An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof. UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 6, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory. Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 6, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

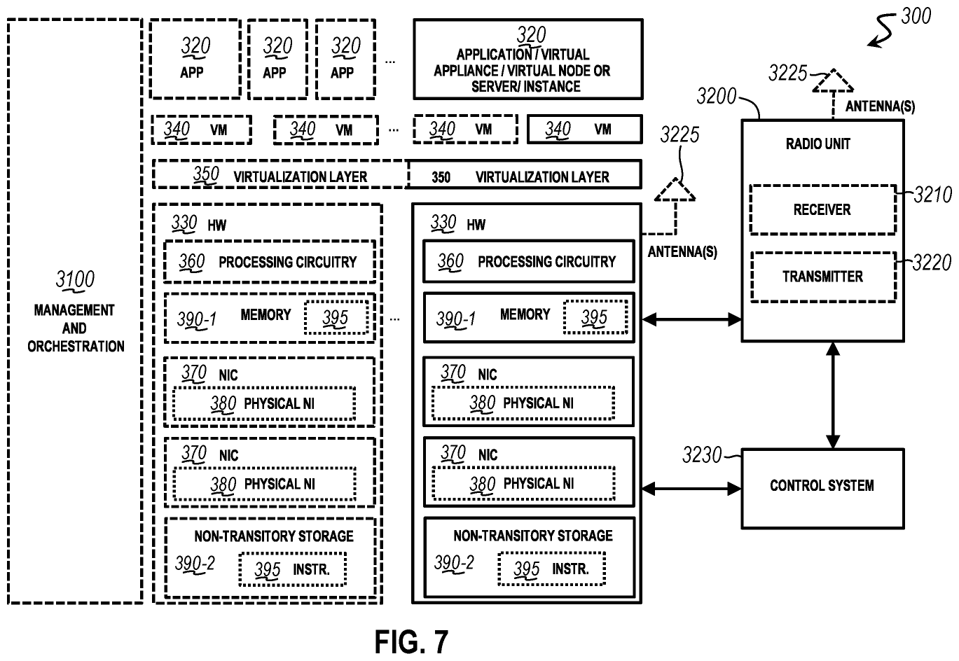

FIG. 7 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 7, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment. In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network element (VNE). Still in the context of NFV, Virtual Network Function (VNF) is responsible for handling specific network functions that run in one or more virtual machines 340 on top of hardware networking infrastructure 330 and corresponds to application 320 in FIG. 7.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station. In some embodiments, some signaling can be effected with the use of control system 3230 which may alternatively be used for communication between the hardware nodes 330 and radio units 3200.

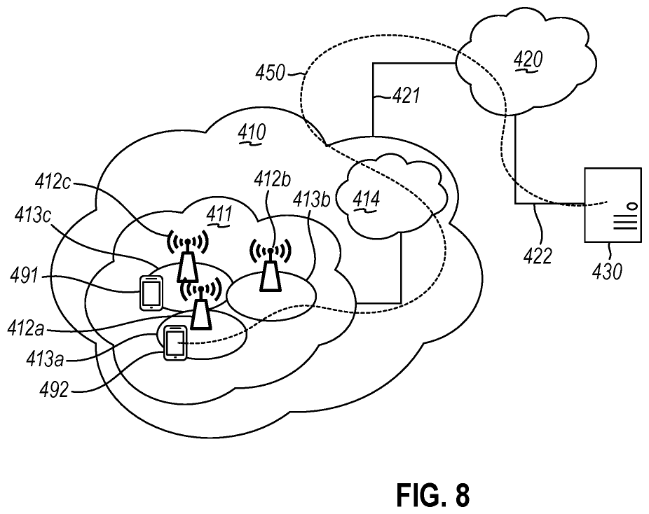

With reference to FIG. 8, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider, or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 8 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

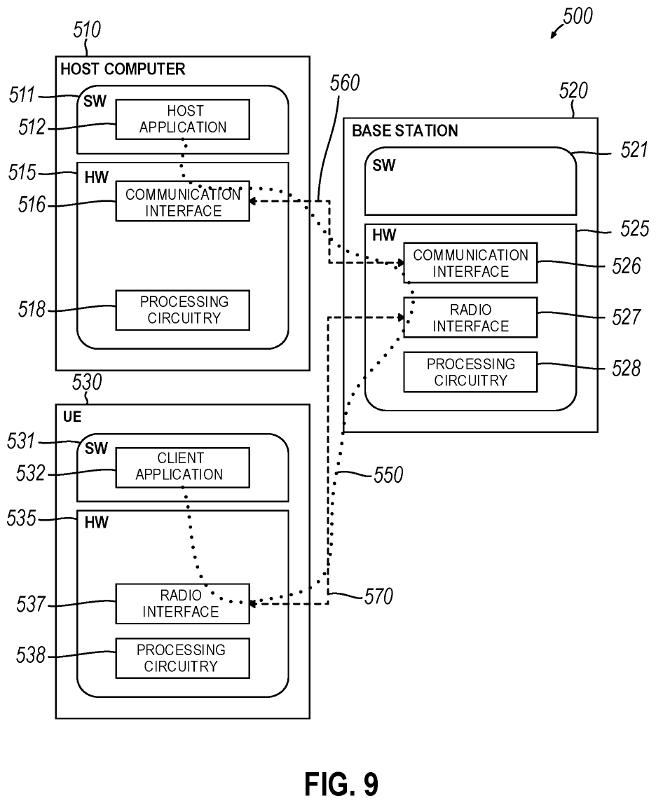

Example implementations, in accordance with an embodiment, of the UE, base station and host computer discussed in the preceding paragraphs will now be described with reference to FIG. 9. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 9) served by base station 520. Communication interface 526 may be configured to facilitate connection 560 to host computer 510. Connection 560 may be direct or it may pass through a core network (not shown in FIG. 9) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 9 may be similar or identical to host computer 430, one of base stations 412a, 412b, 412c and one of UEs 491, 492 of FIG. 8, respectively. This is to say, the inner workings of these entities may be as shown in FIG. 9 and independently, the surrounding network topology may be that of FIG. 8.

In FIG. 9, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve latency and/or power consumption and thereby provide benefits such as reduced user waiting time and/or extended battery lifetime.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above, or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

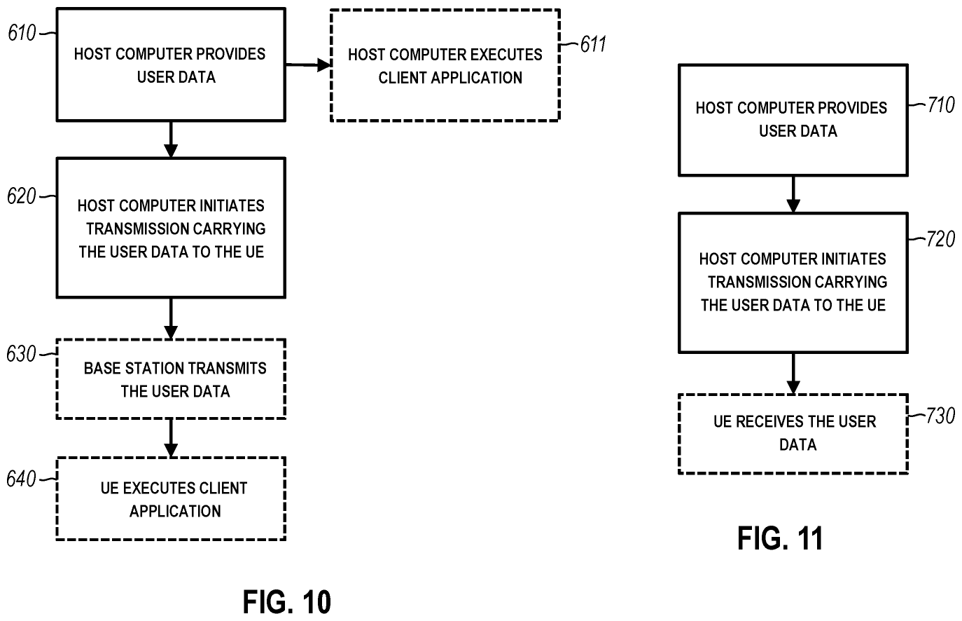

FIG. 10 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 10 will be included in this section. In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 11 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 11 will be included in this section. In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

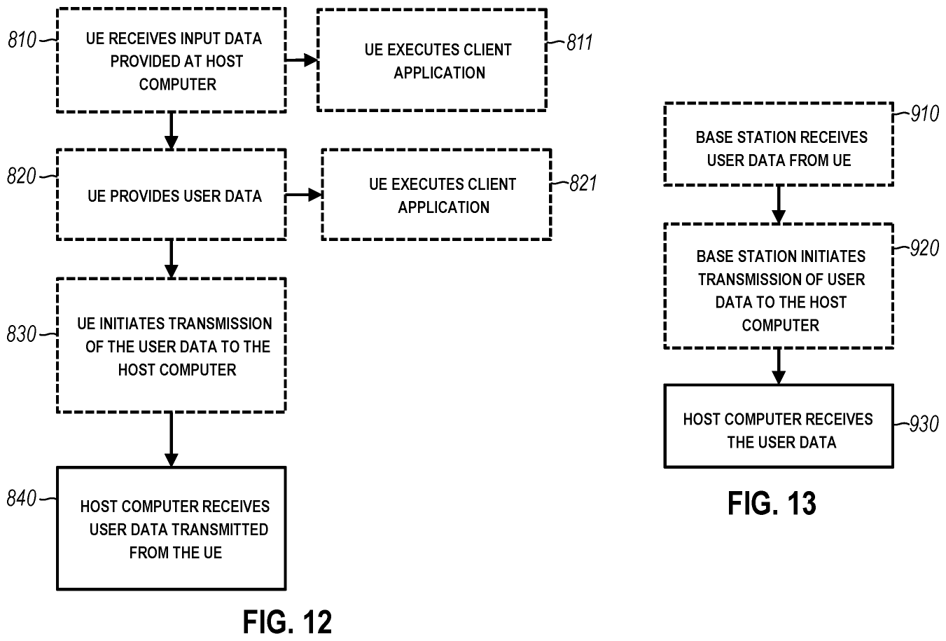

FIG. 12 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 12 will be included in this section. In step 810 (which may be optional), the UE receives input data provided by the host computer. Additionally or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 13 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 13 will be included in this section. In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

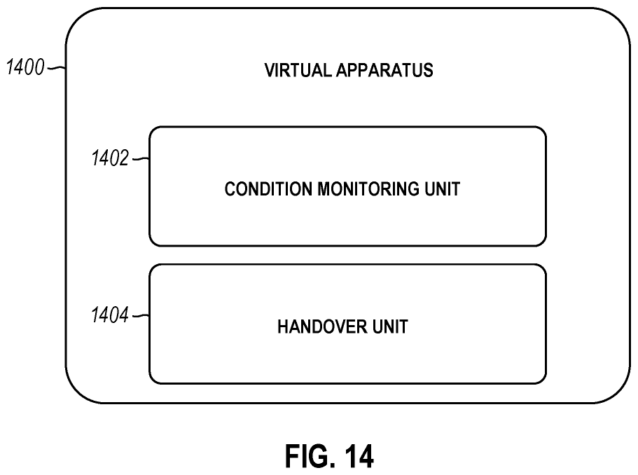

FIG. 14 illustrates a schematic block diagram of an apparatus 1400 in a wireless network (for example, the wireless network shown in FIG. 5). The apparatus may be implemented in a wireless device (e.g., wireless device 110 or UE 200). Apparatus 1400 is operable to carry out the example method described with reference to FIG. 4 and possibly any other processes or methods disclosed herein. It is also to be understood that the method of FIG. 4 is not necessarily carried out solely by apparatus 1400. At least some operations of the method can be performed by one or more other entities.

Virtual Apparatus 1400 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause condition monitoring unit 1402, handover unit 1404, and any other suitable units of apparatus 1400 to perform corresponding functions according one or more embodiments of the present disclosure.

As illustrated in FIG. 14, apparatus 1400 includes condition monitoring unit 1402 and handover unit 1404. In certain embodiments, condition monitoring unit 1402 may receive information from a network node. The information indicates one or more trigger conditions for triggering a conditional handover. The condition monitoring unit 1402 monitors conditions experienced by the wireless device to determine whether one or more of the trigger conditions have been met. The condition monitoring unit 1402 notifies handover unit 1404 when all relevant conditions have been met. In response, handover unit 1404 triggers the handover. For example, certain trigger conditions may each be sufficient to trigger handover on their own. Alternatively, certain trigger conditions may be grouped with/related to other trigger conditions, in which case the condition monitoring unit 1402 may wait to notify handover unit 1404 until all of the grouped/related trigger conditions have been met.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

In some embodiments a computer program, computer program product or computer readable storage medium comprises instructions which when executed on a computer perform any of the embodiments disclosed herein. In further examples the instructions are carried on a signal or carrier and which are executable on a computer wherein when executed perform any of the embodiments disclosed herein.

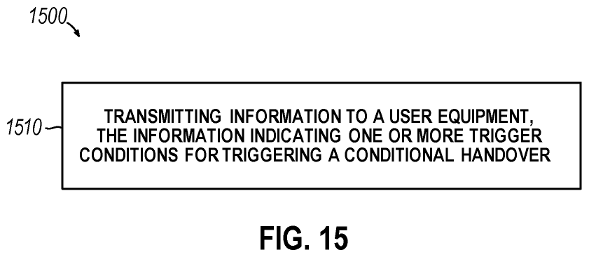

FIG. 15 shows a possible method 1500 performed by a base station for triggering conditional handover in a UE. Step 1510 is transmitting information to a UE, the information indicating one or more trigger conditions for triggering a conditional handover.

### Computer Systems of the Present Disclosure

It will be appreciated that computer systems are increasingly taking a wide variety of forms. In this description and in the claims, the terms “controller,” “computer system,” or “computing system” are defined broadly as including any device or system—or combination thereof—that includes at least one physical and tangible processor and a physical and tangible memory capable of having thereon computer-executable instructions that may be executed by a processor. By way of example, not limitation, the term “computer system” or “computing system,” as used herein is intended to include personal computers, desktop computers, laptop computers, tablets, hand-held devices (e.g., mobile telephones, PDAs, pagers), microprocessor-based or programmable consumer electronics, minicomputers, mainframe computers, multi-processor systems, network PCs, distributed computing systems, datacenters, message processors, routers, switches, and even devices that conventionally have not been considered a computing system, such as wearables (e.g., glasses).

The memory may take any form and may depend on the nature and form of the computing system. The memory can be physical system memory, which includes volatile memory, non-volatile memory, or some combination of the two. The term “memory” may also be used herein to refer to non-volatile mass storage such as physical storage media.

The computing system also has thereon multiple structures often referred to as an “executable component.” For instance, the memory of a computing system can include an executable component. The term “executable component” is the name for a structure that is well understood to one of ordinary skill in the art in the field of computing as being a structure that can be software, hardware, or a combination thereof.

For instance, when implemented in software, one of ordinary skill in the art would understand that the structure of an executable component may include software objects, routines, methods, and so forth, that may be executed by one or more processors on the computing system, whether such an executable component exists in the heap of a computing system, or whether the executable component exists on computer-readable storage media. The structure of the executable component exists on a computer-readable medium in such a form that it is operable, when executed by one or more processors of the computing system, to cause the computing system to perform one or more functions, such as the functions and methods described herein. Such a structure may be computer-readable directly by a processor—as is the case if the executable component were binary. Alternatively, the structure may be structured to be interpretable and/or compiled—whether in a single stage or in multiple stages—so as to generate such binary that is directly interpretable by a processor.

The term “executable component” is also well understood by one of ordinary skill as including structures that are implemented exclusively or near-exclusively in hardware logic components, such as within a field programmable gate array (FPGA), an application specific integrated circuit (ASIC), Program-specific Standard Products (ASSPs), System-on-a-chip systems (SOCs), Complex Programmable Logic Devices (CPLDs), or any other specialized circuit. Accordingly, the term “executable component” is a term for a structure that is well understood by those of ordinary skill in the art of computing, whether implemented in software, hardware, or a combination thereof.

The terms “component,” “service,” “engine,” “module,” “control,” “generator,” or the like may also be used in this description. As used in this description and in this case, these terms—whether expressed with or without a modifying clause—are also intended to be synonymous with the term “executable component” and thus also have a structure that is well understood by those of ordinary skill in the art of computing.

In an embodiment, the communication system may include a complex of computing devices executing any of the method of the embodiments as described above and data storage devices which could be server parks and data centers.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

In general, the various exemplary embodiments may be implemented in hardware or special purpose chips, circuits, software, logic, or any combination thereof. For example, some aspects may be implemented in hardware, while other aspects may be implemented in firmware or software which may be executed by a controller, microprocessor, or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques, or methods described herein may be implemented in, as non-limiting examples, hardware, software, firmware, special purpose circuits or logic, general purpose hardware or controller or other computing devices, or some combination thereof.

While not all computing systems require a user interface, in some embodiments a computing system includes a user interface for use in communicating information from/to a user. The user interface may include output mechanisms as well as input mechanisms. The principles described herein are not limited to the precise output mechanisms or input mechanisms as such will depend on the nature of the device. However, output mechanisms might include, for instance, speakers, displays, tactile output, projections, holograms, and so forth. Examples of input mechanisms might include, for instance, microphones, touchscreens, projections, holograms, cameras, keyboards, stylus, mouse, or other pointer input, sensors of any type, and so forth.

Accordingly, embodiments described herein may comprise or utilize a special purpose or general-purpose computing system. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example—not limitation-embodiments disclosed or envisioned herein can comprise at least two distinctly different kinds of computer-readable media: storage media and transmission media.

Computer-readable storage media include RAM, ROM, EEPROM, solid state drives (“SSDs”), flash memory, phase-change memory (“PCM”), CD-ROM or other optical disk storage, magnetic disk storage or other magnetic storage devices, or any other physical and tangible storage medium that can be used to store desired program code in the form of computer-executable instructions or data structures and that can be accessed and executed by a general purpose or special purpose computing system to implement the disclosed functionality or functionalities. For example, computer-executable instructions may be embodied on one or more computer-readable storage media to form a computer program product.

Transmission media can include a network and/or data links that can be used to carry desired program code in the form of computer-executable instructions or data structures and that can be accessed and executed by a general purpose or special purpose computing system. Combinations of the above should also be included within the scope of computer-readable media.

Further, upon reaching various computing system components, program code in the form of computer-executable instructions or data structures can be transferred automatically from transmission media to storage media (or vice versa). For example, computer-executable instructions or data structures received over a network or data link can be buffered in RAM within a network interface module (e.g., a “NIC”) and then eventually transferred to computing system RAM and/or to less volatile storage media at a computing system. Thus, it should be understood that storage media can be included in computing system components that also—or even primarily-utilize transmission media.

Those skilled in the art will further appreciate that a computing system may also contain communication channels that allow the computing system to communicate with other computing systems over, for example, a network. Accordingly, the methods described herein may be practiced in network computing environments with many types of computing systems and computing system configurations. The disclosed methods may also be practiced in distributed system environments where local and/or remote computing systems, which are linked through a network (either by wired data links, wireless data links, or by a combination of wired and wireless data links), both perform tasks. In a distributed system environment, the processing, memory, and/or storage capability may be distributed as well.

Those skilled in the art will also appreciate that the disclosed methods may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

### Abbreviations and Defined Terms

To assist in understanding the scope and content of this written description and the appended claims, a select few terms are defined directly below. Unless defined otherwise, all technical and scientific terms used herein have the same meaning as commonly understood by one of ordinary skill in the art to which the present disclosure pertains.

Unless otherwise stated explicitly, the terms cell and beam are used interchangeably in this document. The terms “wireless terminal”, “User Equipment”, “UE”, “wireless device” and “device” are used interchangeably in this document.

Source cell or target cell do not refer to the global cell ID in this disclosure assuming that a global cell ID is mapped to a geographical area in a tracking area, which is also defined with respect to a geographical area.

Certain embodiments are described using NR terminology, e.g. using the term “gNB” instead of the more generic and RAT-independent term “radio base station”, but this should not be seen as a limitation, as the solution is applicable also to other RATs that may be used in NTNs, such as LTE.

The terms “CHO event” and “CHO trigger condition” are used interchangeably in the present disclosure. Similarly, the terms “event” and “trigger condition” and “condition” in the context of CHO are used interchangeably and are then equivalent to the terms “CHO event” and “CHO trigger condition” (but note that these terms may be used in the context of measurement reporting too).

The signal quality/strength based triggers (events) indicated in the description may either be one of the Rel-16 CHO events A3 (Neighbour becomes offset better than SpCell) or A5 (SpCell becomes worse than threshold1 and neighbour becomes better than threshold2) or a new Rel-17 CHO event, e.g. A4 (Neighbour becomes better than threshold).

The terms “approximately,” “about,” and “substantially,” as used herein, represent an amount or condition close to the specific stated amount or condition that still performs a desired function or achieves a desired result. For example, the terms “approximately,” “about,” and “substantially” may refer to an amount or condition that deviates by less than 10%, or by less than 5%, or by less than 1%, or by less than 0.1%, or by less than 0.01% from a specifically stated amount or condition.

Various aspects of the present disclosure, including devices, systems, and methods may be illustrated with reference to one or more embodiments or implementations, which are exemplary in nature. As used herein, the term “exemplary” means “serving as an example, instance, or illustration,” and should not necessarily be construed as preferred or advantageous over other embodiments disclosed herein. In addition, reference to an “implementation” of the present disclosure or embodiments includes a specific reference to one or more embodiments thereof, and vice versa, and is intended to provide illustrative examples without limiting the scope of the present disclosure, which is indicated by the appended claims rather than by the present description.

As used in the specification, a word appearing in the singular encompasses its plural counterpart, and a word appearing in the plural encompasses its singular counterpart, unless implicitly or explicitly understood or stated otherwise. Thus, it will be noted that, as used in this specification and the appended claims, the singular forms “a,” “an” and “the” include plural referents unless the context clearly dictates otherwise. For example, reference to a singular referent (e.g., “a widget”) includes one, two, or more referents unless implicitly or explicitly understood or stated otherwise. Similarly, reference to a plurality of referents should be interpreted as comprising a single referent and/or a plurality of referents unless the content and/or context clearly dictate otherwise. For example, reference to referents in the plural form (e.g., “widgets”) does not necessarily require a plurality of such referents. Instead, it will be appreciated that independent of the inferred number of referents, one or more referents are contemplated herein unless stated otherwise.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

The following abbreviations are used in the present disclosure:

| | |
|---|---|
| 1x RTT | CDMA2000 1x Radio Transmission Technology |
| 3GPP | 3rd Generation Partnership Project |
| 5G | 5th Generation |
| 5GC | 5G Core |
| ABS | Almost Blank Subframe |
| ARQ | Automatic Repeat Request |
| AWGN | Additive White Gaussian Noise |
| BCCH | Broadcast Control Channel |
| BCH | Broadcast Channel |
| BS | Base Station |
| CA | Carrier Aggregation |
| CC | Carrier Component |
| CCCH SDU | Common Control Channel SDU |
| CDMA | Code Division Multiplexing Access |
| CE | Control Element |
| CGI | Cell Global Identifier |
| CHO | Conditional Handover |
| CIR | Channel Impulse Response |
| CLI | Cross Link Interference |
| CN | Core Network |
| CP | Control Plane |
| CPC | Conditional PSCell Change |
| CPICH | Common Pilot Channel |
| CPICH Ec/No | CPICH Received energy per chip divided |
| | by the power density in the band |
| CQI | Channel Quality information |
| C-RNTI | Cell RNTI |
| CSI | Channel State Information |
| CSI-RS | Channel State Information - Reference Signal |
| CU | Central Unit |
| DAPS | Dual Active Protocol Stack |
| DCCH | Dedicated Control Channel |
| DCI | Downlink Control Information |
| DL | Downlink |
| DM | Demodulation |
| DMRS | Demodulation Reference Signal |
| DRX | Discontinuous Reception |
| DTCH | Dedicated Traffic Channel |
| DTX | Discontinuous Transmission |
| DU | Distributed Unit |
| DUT | Device Under Test |
| ECGI | Evolved CGI |
| E-CID | Enhanced Cell-ID (positioning method) |
| eNB | Evolved NodeB (LTE base station) |
| EPC | Evolved Packet Core |
| ePDCCH | enhanced Physical Downlink Control Channel |
| E-SMLC | Evolved-Serving Mobile Location Centre |
| E-UTRA | Evolved Universal Terrestrial Radio Access |
| E-UTRAN | Evolved UTRAN |
| F1 | The interface between a CU and a DU in a gNB. |
| FDD | Frequency Division Duplex |
| FFS | For Further Study |
| FR1 | Frequency Range 1 |
| GEO | Geostationary Orbit |
| GERAN | GSM EDGE Radio Access Network |
| gNB | Base station in NR |
| GNSS | Global Navigation Satellite System |
| GPS | Global Positioning System |
| GSM | Global System for Mobile communication |
| GW | Gateway |
| HAPS | High Altitude Platform System |
| HARQ | Hybrid Automatic Repeat Request |
| HO | Handover |
| HRPD | High Rate Packet Data |
| HSPA | High Speed Packet Access |
| ID | Identifier |
| IE | Information Element |
| LEO | Low Earth Orbit |
| LOS | Line of Sight |
| LPP | LTE Positioning Protocol |
| LTE | Long Term Evolution |
| MAC | Medium Access Control |
| MAC CE | MAC Control Element |
| MBMS | Multimedia Broadcast Multicast Services |
| MBSFN | Multimedia Broadcast multicast service Single |
| | Frequency Network |
| MBSFN ABS | MBSFN Almost Blank Subframe |
| MDT | Minimization of Drive Tests |
| MEO | Medium Earth Orbit |
| MIB | Master Information Block |
| MME | Mobility Management Entity |
| MO | Measurement Object |
| MSC | Mobile Switching Center |
| NAS | Non Access Stratum |
| NG | The interface between NG-RAN and 5GC. |
| | (Also: “Next Generation”.) |
| NGc | The control plane part of the NG interface. |
| NG-RAN | Next Generation RAN |
| NGSO | Non-Geostationary Object |
| NGu | The user plane part of the NG interface. |
| NPDCCH | Narrowband Physical Downlink Control Channel |
| NR | New Radio |
| NTN | Non-Terrestrial Network |
| NW | Network |
| O&M | Operation and Maintenance |
| OCNG OFDMA | Channel Noise Generator |
| OFDM | Orthogonal Frequency Division Multiplexing |
| OFDMA | Orthogonal Frequency Division Multiple Access |
| OSS | Operations Support System |
| OTDOA | Observed Time Difference of Arrival |
| PBCH | Physical Broadcast Channel |
| P-CCPCH | Primary Common Control Physical Channel |
| PCell | Primary Cell |
| PCFICH | Physical Control Format Indicator Channel |
| PDCCH | Physical Downlink Control Channel |
| PDCP | Packet Data Convergence Protocol |
| PDP | Profile Delay Profile |
| PDSCH | Physical Downlink Shared Channel |
| PGW | Packet Gateway |
| PHICH | Physical Hybrid-ARQ Indicator Channel |
| PHY | Physical layer |
| PLMN | Public Land Mobile Network |
| PMI | Precoder Matrix Indicator |
| P-RNTI | Paging RNTI |
| PRACH | Physical Random Access Channel |
| PRS | Positioning Reference Signal |
| PSCell | Primary Secondary Cell |
| PSS | Primary Synchronization Signal |
| PUCCH | Physical Uplink Control Channel |
| PUSCH | Physical Uplink Shared Channel |
| QAM | Quadrature Amplitude Modulation |
| RACH | Random Access Channel |
| RAN | Radio Access Network |
| RAN1 | 3GPP TSG-RAN WG1 |
| RAN2 | 3GPP TSG-RAN WG2 |
| RAN3 | 3GPP TSG-RAN WG3 |
| RAT | Radio Access Technology |
| RF | Radio Frequency |
| RLC | Radio Link Control |
| RLM | Radio Link Management |
| RNC | Radio Network Controller |
| RNL | Radio Network Layer |
| RNTI | Radio Network Temporary Identifier |
| RRC | Radio Resource Control |
| RRM | Radio Resource Management |
| RS | Reference Signal |
| RSRP | Reference Signal Received Power |
| RSRQ | Reference Signal Received Quality |
| RSSI | Received Signal Strength Indicator |
| RSTD | Reference Signal Time Difference |
| RX | Receive/Receiver/Reception |
| SCell | Secondary Cell |
| SCH | Synchronization Channel |
| SDU | Service Data Unit |
| SFN | System Frame Number |
| SGW | Serving Gateway |
| SI | System Information |
| SIB | System Information Block |
| SINR | Signal to Interference and Noise Ratio |
| SMTC SSB | Measurement Timing Configuration |
| SN | Sequence Number |
| SNPN | Stand-alone Non-Public Network |
| SNR | Signal to Noise Ratio |
| SON | Self Optimized Network |
| SRS | Sounding Reference Signal |
| SS | Synchronization Signal |
| SSB | Synchronization Signal Block |
| SSS | Secondary Synchronization Signal |
| SUL | Supplementary Uplink |
| TA | Timing Advance |
| TDD | Time Division Duplex |
| TDOA | Time Difference of Arrival |
| TNL | Transport Network Layer |
| TOA | Time of Arrival |
| TR | Technical Report |
| TS | Technical Specification |
| TSG | Technical Specification Group |
| TSS | Tertiary Synchronization Signal |
| TTI | Transmission Time Interval |
| TTT | Time to Trigger |
| TX | Transmit/Transmitter/Transmission |
| UE | User Equipment |
| UL | Uplink |
| UMTS | Universal Mobile Telecommunication System |
| UP | User Plane |
| USIM | Universal Subscriber Identity Module |
| UTDOA | Uplink Time Difference of Arrival |
| UTRA | Universal Terrestrial Radio Access |
| UTRAN | Universal Terrestrial Radio Access Network |
| VPLMN | Visited PLMN |
| WCDMA | Wide CDMA |
| WG | Working Group |
| WLAN | Wide Local Area Network |
| X2 | Interface between two eNBs in LTE |
| Xn | Interface between two gNBs in NR |

### CONCLUSION

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

It is understood that for any given component or embodiment described herein, any of the possible candidates or alternatives listed for that component may generally be used individually or in combination with one another, unless implicitly or explicitly understood or stated otherwise. Additionally, it will be understood that any list of such candidates or alternatives is merely illustrative, not limiting, unless implicitly or explicitly understood or stated otherwise.

In addition, unless otherwise indicated, numbers expressing quantities, constituents, distances, or other measurements used in the specification and claims are to be understood as being modified by the term “about,” as that term is defined herein. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

Any headings and subheadings used herein are for organizational purposes only and are not meant to be used to limit the scope of the description or the claims. The terms and expressions which have been employed herein are used as terms of description and not of limitation, and there is no intention in the use of such terms and expressions of excluding any equivalents of the features shown and described or portions thereof, but it is recognized that various modifications are possible within the scope of the present disclosure. Thus, it should be understood that although the present disclosure has been specifically disclosed in part by preferred embodiments, exemplary embodiments, and optional features, modification and variation of the concepts herein disclosed may be resorted to by those skilled in the art, and such modifications and variations are considered to be within the scope of this present description.

It will also be appreciated that systems, devices, products, kits, methods, and/or processes, according to certain embodiments of the present disclosure may include, incorporate, or otherwise comprise properties or features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

All references cited in this application are hereby incorporated in their entireties by reference to the extent that they are not inconsistent with the disclosure in this application. It will be apparent to one of ordinary skill in the art that methods, devices, device elements, materials, procedures, and techniques other than those specifically described herein can be applied to the practice of the described embodiments as broadly disclosed herein without resort to undue experimentation. All art-known functional equivalents of methods, devices, device elements, materials, procedures, and techniques specifically described herein are intended to be encompassed by this present disclosure.

When a group of materials, compositions, components, or compounds is disclosed herein, it is understood that all individual members of those groups and all subgroups thereof are disclosed separately. When a Markush group or other grouping is used herein, all individual members of the group and all combinations and sub-combinations possible of the group are intended to be individually included in the disclosure.

The above-described embodiments are examples only. Alterations, modifications, and variations may be effected to the particular embodiments by those of skill in the art without departing from the scope of the description, which is defined solely by the appended claims.

1. A method performed by a user equipment (UE) for triggering conditional handover, the method comprising:
receiving information from a network node, the information indicating one or more trigger conditions for triggering a conditional handover to a target cell;
determining whether a first of the one or more trigger conditions has been met; and
triggering the conditional handover based at least in part on determining that the first trigger condition has been met.

2. The method of claim 1, wherein the one or more trigger conditions comprise at least one of: one or more location-based, one or more time/timer-based, and one or more signal strength/quality-based trigger conditions.

3. The method of claim 1, further comprising determining a set of the one or more trigger conditions for which each trigger condition in the set must be met in order to trigger the conditional handover, the set comprising the first trigger condition and at least one other trigger condition;
wherein triggering the conditional handover is further based on determining that each trigger condition in the set has been met.

4. The method of claim 1, wherein one or more location-based and one or more time/timer-based trigger conditions are configured for the UE if one or more signal strength/quality-based trigger conditions are not configured for the UE.

5. The method of claim 1, wherein only one of: one or more location-based, one or more time/timer-based, and one or more signal strength/quality-based trigger conditions, are configured for the UE.

6. The method of claim 1 wherein one or more location-based and one or more time/timer-based trigger conditions are configured together.

7. The method of claim 1 wherein one or more signal strength/quality-based trigger conditions are configured with one of: one or more location-based and one or more time/timer-based trigger conditions.

8. The method of claim 1 wherein the UE is configured to determine if it supports one or more location-based trigger conditions and if the one or more location-based trigger conditions can be configured with at least one of: one or more time/timer-based and one or more signal strength/quality-based trigger conditions.

9. The method of claim 1 wherein the UE is configured to determine if it supports one or more time/timer-based trigger conditions and if the one or more time/timer-based trigger conditions can be configured with at least one of: one or more location-based trigger conditions and one or more signal strength/quality-based trigger conditions.

10. The method of claim 1 wherein one or more location-based and/or one or more time/timer-based trigger conditions have to always be configured with one or more signal strength/quality-based trigger conditions.

11. The method of claim 1, wherein one or more location-based trigger conditions includes a serving cell reference location and/or a target cell reference location received by the UE in at least one of: measurement configuration, trigger condition configuration, Radio Resource Control (RRC) dedicated configuration, system information, or Ephemeris information.

12. The method of claim 11 wherein the one or more location-based trigger condition is configured to trigger if a distance to the serving cell reference location is longer than a distance to the target reference cell location.

13. The method of claim 11 wherein the one or more location-based trigger condition is configured to trigger based on a combination of distance to the serving cell reference location and distance to the target cell reference location.

14. The method of claim 1 wherein the one or more trigger conditions are UE specific.

15. The method of claim 14 wherein the one or more trigger conditions are defined by specification or RRC parameters.

16. The method of claim 14 wherein one or more location-based trigger conditions is based on a distance from the UE to a serving cell reference location without reference to a distance to a target cell reference location.

17. The method of claim 1 wherein the UE simultaneously evaluates all of the one or more trigger conditions for one or more possible target cells configured for the UE, and a conditional handover to a target cell is triggered only if all of the one or more trigger conditions for that target cell are fulfilled.

18. The method of claim 1 wherein a subset of all possible one or more trigger conditions are configured for all possible target cells.

19. The method of claim 1 wherein for each of one or more possible target cells a different set of one or more trigger conditions are configured.

20. The method of claim 1 wherein each of one or more possible target cells are evaluated with a different one or more trigger conditions.

21. The method of claim 1 wherein the UE evaluates all or a subset of the one or more trigger conditions for all of one or more possible target cells and if one of the one or more trigger conditions is fulfilled by one of the one or more possible target cells then the conditional handover is triggered for that target cell.

22. The method of claim 1 wherein the UE evaluates all or a subset of the one or more trigger conditions for all of one or more possible target cells and if multiple of the one or more trigger conditions is fulfilled by one of the one or more possible target cells then the conditional handover is triggered for that target cell.

23. The method of claim 1 wherein the UE evaluates the one or more trigger conditions in a hierarchical order.

24. The method of claim 23 wherein the UE only evaluates a subsequent one of the one or more trigger conditions if the preceding one has been fulfilled.

25.-51. (canceled)

52. A method performed by a base station for triggering conditional handover in a user equipment (UE), the method comprising transmitting information to a UE, the information indicating one or more trigger conditions for triggering a conditional handover.

53.-103. (canceled)

104. A user equipment (UE), the UE comprising:
processing circuitry configured to:
receive information from a network node, the information indicating one or more trigger conditions for triggering a conditional handover to a target cell;
determine whether a first of the one or more trigger conditions has been met; and
trigger the conditional handover based at least in part on determining that the first trigger condition has been met; and
power supply circuitry configured to supply power to the UE.

105.-141. (canceled)
